(19) United States
(12) Patent Application Publication
(10) Pub. No.: US 2005/0083711 A1
(43) Pub. Date: Apr. 21, 2005

(54) Assembly structure of a back light module

(76) Inventors: Sheng-Chun Wu, Hsinchu Hsien (TW); Tsung-Cheng Liu, Hsinchu Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/686,653

(22) Filed: Oct. 17, 2003

(51) Int. Cl. F21V 11/00; F21V 7/04

(52) U.S. Cl. 362/558; 362/224; 362/225

(57) ABSTRACT

The invention provides an assembly structure of a back light module having two horizontal frames, two vertical frames and an optical plate. At both ends of each horizontal frame and vertical frame is equipped noncircular holes and pillars, and a plurality of chutes is equipped on the corresponding surfaces of the two horizontal frames to intervene each other for assembling the two horizontal frames and the two vertical frames to a complete frame. The two sides of the optical plate are formed the fixed supports that have a slant corresponding to the chute for installing the optical plate into the complete frame, and the fixed support is embedded into the chute of the horizontal frame. In accordance with the design of embedded structure, the invention can achieve effects of easy assembly, firm structure, low cost and easy disassembling.

### BACKGROUND OF INVENTION

1. Field of the Invention

The invention relates to a back light module, and more particularly, to an assembly structure of a back light module that firmly assembled by interfered conjugation.

2. Description of the Prior Art

The traditional back light module equips a plurality of lamps at two ends of a frame, and makes the light projecting from two sides into the whole diffusion plate. Since the intensity of the light is getting weaker with the distance, the light intensity at the central part of the diffusion plate is weaker than that at two sides, and the light intensity of the whole diffusion plate is not uniform. Therefore, the back light module of the direct type lamp is developed. The direct type lamp is transversely equipped at the back light position of the diffusion plate in the back light module. When lighting the lamp, the light is uniformly diffused in the diffusion plate without the disadvantage mentioned above.

However, whatever side projecting type or direct type of the back light module, the assembly structure is formed by installing a diffusion plate into a once-formed frame and fixing the diffusion plate with the frame by glue. The frame for this kind of assembly structure has not only high cost but also large volume that are inconvenient for packaging and transporting. In addition, fixing by glue has problem in orientation and increases manufacture cost. Furthermore, the traditional side projecting lamp need a metal device to fix the lamp and the direct type lamp also need a fixing device to fix the lamp that has the disadvantage of complex manufacture and uneasy assembly.

Therefore, the present invention provides a back light module that has characteristics of tight combination and easy assembly to solve the disadvantages mentioned above.

### SUMMARY OF INVENTION

It is therefore a primary objective of the claimed invention to provide an assembly structure of a back light module that can achieve effects of easy assembly and firm structure with the embedded structure of separated frames by interfered conjugation and contacting in multi points.

It is therefore another objective of the claimed invention to firmly fix the optical plate with the frame by the chute of the frame and the fixed support of the optical plat without using glue. The disadvantage of fixing by glue can be thoroughly solved.

It is therefore a further objective of the claimed invention to provide a back light module with advantages of low cost and easy assembly that differ to the traditional once-formed and glue-fixed frame.

According to the invention, an assembly structure of a back light module comprises two horizontal frames equipped in parallel, both ends of each horizontal frame have a first noncircular hole and a first pillar, and a plurality of chutes is respectively set on oppositive surfaces of the two horizontal frames; two vertical frames equipped in parallel, both ends of each vertical frame have a second pillar and a second noncircular hole respectively match to the first noncircular hole and the first pillar, and one horizontal frame and the two vertical frames intervene each other with the noncircular holes and the pillars and assemble to a [symbol] -shape frame; and an optical plate whose two sides are formed a fixed support, the fixed support has a slant corresponding to the chute, and the optical plate is installed in the [symbol] -shape frame, and another horizontal frame and the two vertical frames intervene each other to fix the optical plate.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a 3-dimentional diagram according to present invention.

FIG. 2 is an embedded structure diagram of the frame according to present invention.

FIG. 3 is a diagram of the optical plate embedded into the chute according to present invention.

FIG. 4 is an assembly diagram according to present invention.

FIG. 5 is a partial diagram of the lamp equipped on the frame according to present invention.

### DETAILED DESCRIPTION

The present invention provides an assembly structure of a back light module that is equipped a multi-point structure intervened each other at the ends of the separated frame. With the chute at the sides of the frame, the optical plate can be assembled with the frames to acieve a firmly fixed back light module.

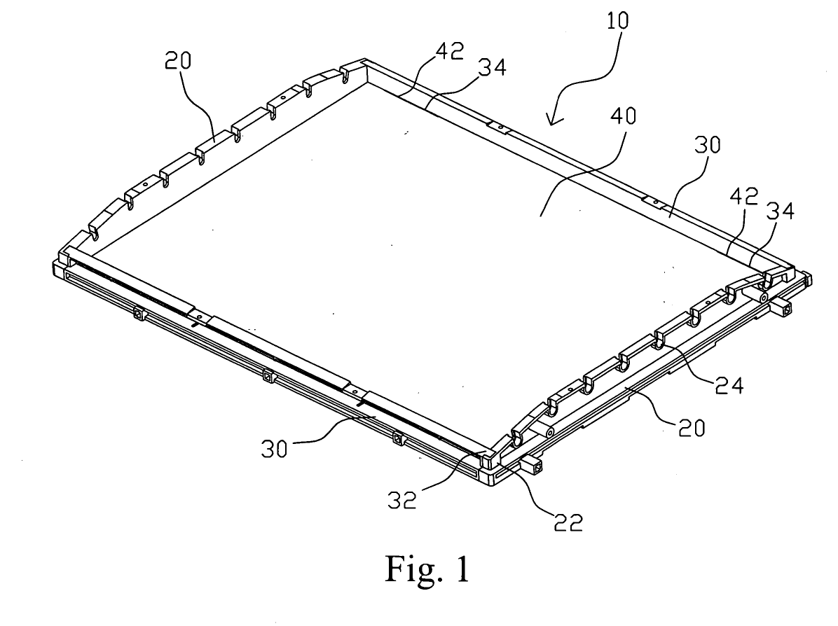

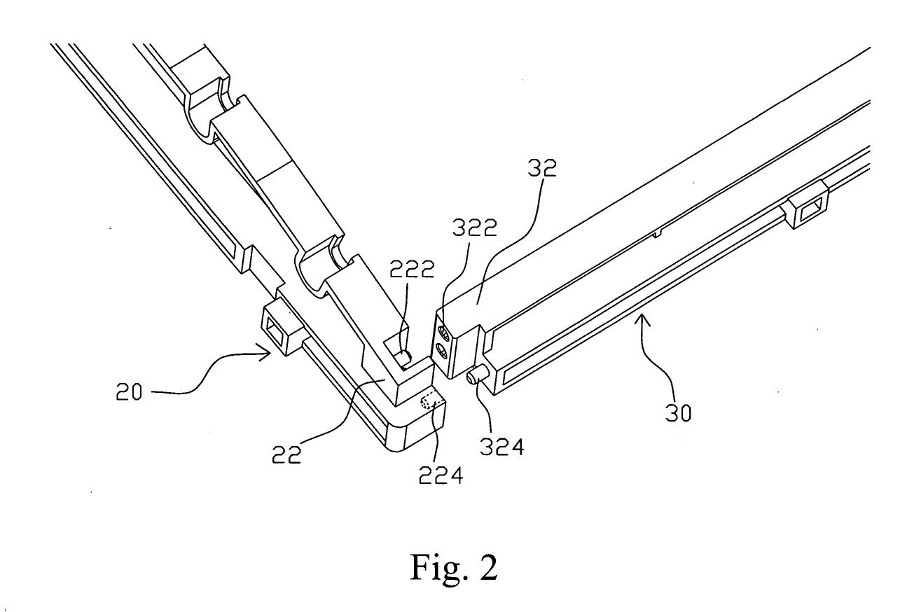

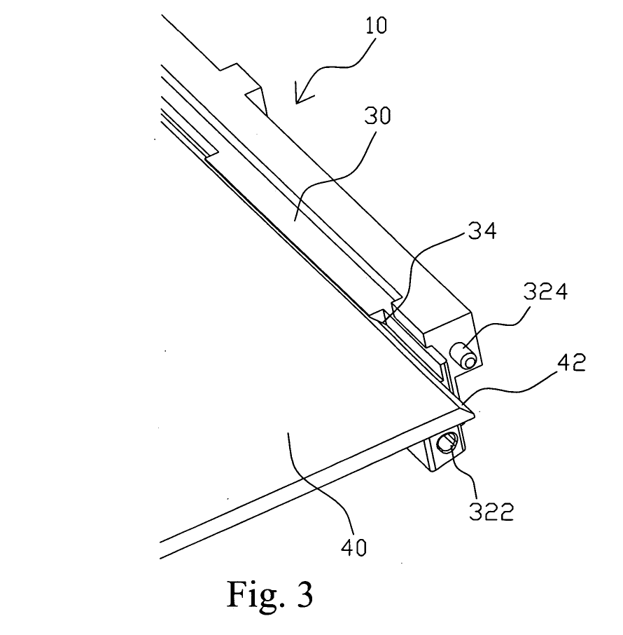

Please refer to FIG. 1, the complete frame of the back light module 10 is composes of two parallel vertical frames 20 and two parallel horizontal frames 30, and an optical plate 40 is embedded in the frame. Please refer to FIG. 2 and FIG. 3, FIG. 2 and FIG. 3 are assembly structure diagrams according to present invention. Both ends of each horizontal frame 30 are equipped an embedding location 32 composed of two noncircular holes 322 and a pillar 324, and two chutes 34 are set on oppositive surfaces of the two horizontal frames 30; Both ends of the vertical frame 20 also have an embedding location 22 having two pillars 222 and a noncircular hole 224 respectively match to the noncircular hole 322 and the pillar 324 on the horizontal frame 30. The noncircular hole 322 and the pillar 324 on the horizontal frame 30 are aimed at and embedded into the pillar 222 and the noncircular hole 224 on the vertical frame 20. With intervening each other of the pillars 222, 324 and the noncircular holes 224, 322, the pillars 222, 324 are embedded into the noncircular holes 224, 322, and are assembled to achieve a firm back light module with multi point contacts.

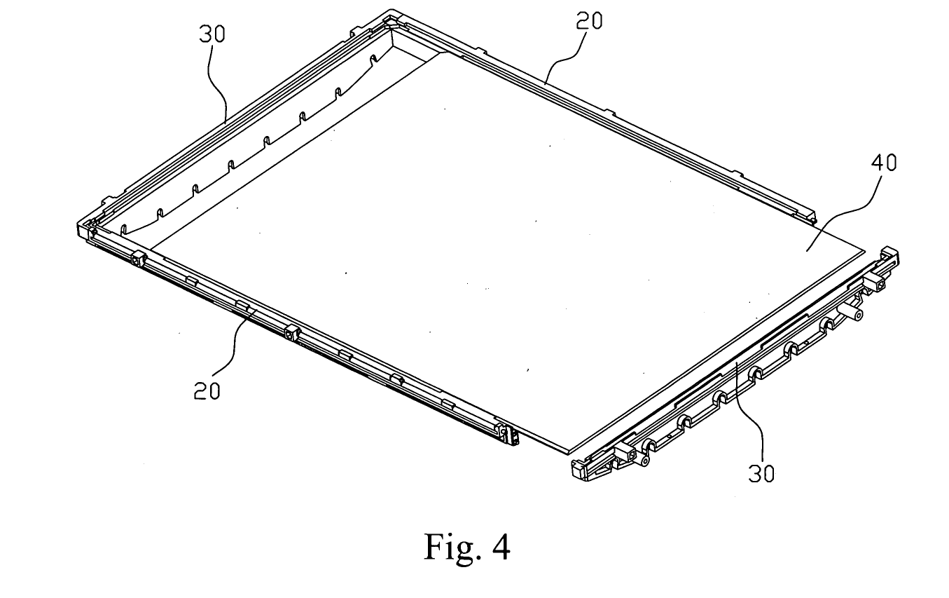

A plurality of fillisters 24 is respectively equipped on the two vertical frames 20, and the optical plate 40 is usually a light guide plate or a diffusion plate. As FIG. 3 shows, two sides of the optical plate 40 are formed a fixed support 42, the fixed support 42 has a slant corresponding to the chute 34 of the horizontal frame 30. When assembling the frames and the optical plate 40, as FIG. 4 shows, one horizontal frame 30 and two vertical frames 20 intervene each other with the noncircular holes 322, 224 and the pillars 324, 222, and assemble to a [symbol] -shape frame that forms a placing space. Then, the optical plate 40 is installed in the placing space by pushing along the [symbol] -shape frame, and the fixed support 42 of the optical plate 40 slides into the chute 34 of the horizontal frame 30 and is embed in the chute 34. Then, the second horizontal frame 30 and the two vertical frames 20 intervene each other, and at this moment the chute 34 of the second horizontal frame 30 just embeds the fixed support 42 on the side of the optical plate 40 to fix the optical plate 40 with the frame of the back light module.

Since the assembly method of the optical plate 40 and the frame is mechanical embedding, the method is different from the traditional one that is orientated by frame shape and fixed by glue. The design of slants embedding each other for the present invention not only omits persecutions of orientating by frame shape and fixing by glue, but also reduces the assembling cost. In addition, the module of present invention is easily disassembled to prevent cleaning the glue when reworking.

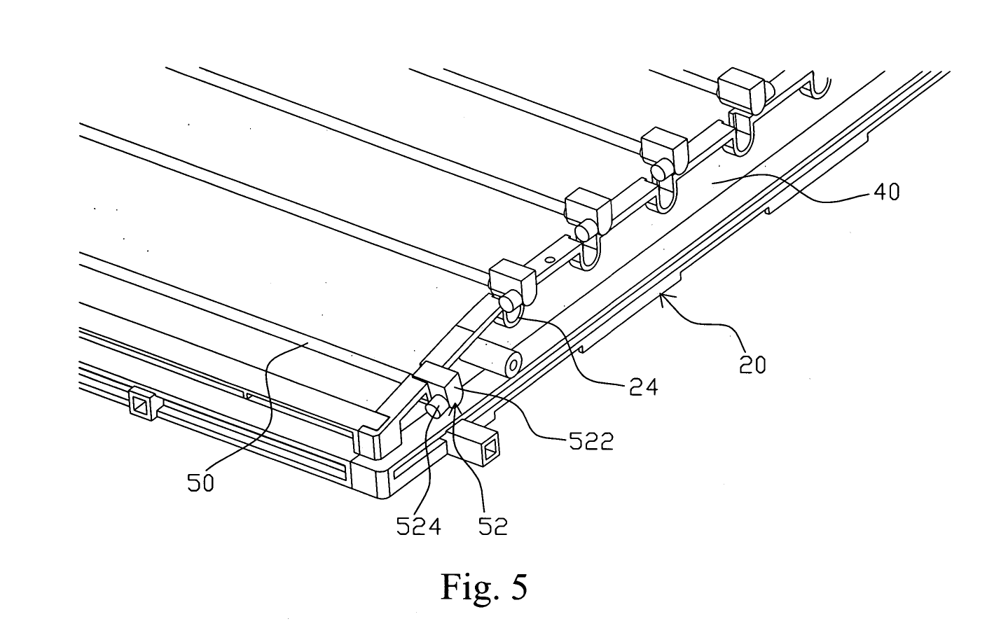

Please further refer to FIG. 5, FIG. 5 is a partial diagram of the lamp equipped on the frame according to present invention. A plurality of lamps 50 is equipped at the back light position of the optical plate 40, and is installed on the two vertical frames 20. The lamp 50 is usually a cold cathode fluorescent lamp, both ends of each lamp 50 are equipped an electrode protection sleeve 52 whose material is soft rubber or plastic. The electrode protection sleeve 52 is composed of a pedestal 522 and a prominence 524, wherein the size of the pedestal 522 is larger than that of the fillister 24 of the vertical frame 20. The pedestal 522 is pressed into the fillister 24 and makes the prominence 524 sticking out the fillister 24 to limit the longitudinal movement of the lamp 50 with the intervening design. The lamp 50 is firmly fixed on the frame without any other appurtenance. This kind of embedding structure is more convenient and cheaper than the traditional side projection structure that need a metal device to fix the lamp. In comparison with the fixing structure of the direct type lamp that needs a fixing device, the embedding structure is easy to assemble and reduce the cost of fixing devices.

In accordance with the request of design, the fillister 24 located on the vertical frame 20 can be also equipped on the two horizontal frames 30 to install the lamp 50 on the two horizontal frames 30.

Furthermore, after assembling the above-mentioned structure, a cover (not showed in figures) can be further equipped at the back light position of the optical plate 40 and the lamp 50. The four borders of the cover are fixed to the two horizontal frames 30 and the two vertical frames 20 with screws to firmly fix the lamp 50 for avoiding light leakage.

Hence the present invention uses the separated frames to forsake the traditional once-formed frame and glue-fixing method. The frames intervene each other with the noncircular holes and the pillars, and are embedded with the chutes of the frames and the fixed supports of the optical plate. The present invention can achieve effects of easy assembly, firm structure, low cost and easy disassembling. Embedding both ends of the lamp into the fillisters of the frame can form a firm structure and achieve advantage of convenient replacement.

Those skilled in the art will readily observe that numerous modifications and alterations of the device may be made while retaining the teachings of the invention. Accordingly, the above disclosure should be construed as limited only by the metes and bounds of the appended claims.

1. An assembly structure of a back light module, comprising:
two horizontal frames equipped in parallel, both ends of each horizontal frame have a first noncircular hole and a first pillar, and a plurality of chutes is respectively set on the appositive surfaces of the two horizontal frames;
two vertical frames equipped in parallel, both ends of each vertical frame have a second pillar and a second noncircular hole respectively match to the first noncircular hole and the first pillar, and one horizontal frame and the two vertical frames intervene each other with the noncircular holes and the pillars and are assembled to a [symbol] -shape frame; and
an optical plate whose two sides are formed a fixed support, the fixed support has a slant corresponding to the chute, and the optical plate is installed in the [symbol] -shape frame, and another horizontal frame and the two vertical frames intervene each other to fix the optical plate.

2. The assembly structure of the back light module of claim 1 wherein further comprises a plurality of lamps equipped on a back light position of the optical plate, and both ends of each lamp have an electrode protection sleeve.

3. The assembly structure of the back light module of claim 2 wherein a material of the electrode protection sleeve is selected from a rubber and a plastic.

4. The assembly structure of the back light module of claim 2 wherein a plurality of fillisters is respectively equipped on the two horizontal frames for installing the electrode protection sleeves on the two ends of each lamp into the fillisters of the two horizontal frames.

5. The assembly structure of the back light module of claim 2 wherein a plurality of fillisters is respectively equipped on the two vertical frames for installing the electrode protection sleeves on the two ends of each lamp into the fillisters of the two vertical frames.

6. The assembly structure of the back light module of claim 4 wherein the electrode protection sleeves on the two ends of the lamp and the fillisters are assembled with intervention method.

7. The assembly structure of the back light module of claim 5 wherein the electrode protection sleeves on the two ends of the lamp and the fillisters are assembled with intervention method.

8. The assembly structure of the back light module of claim 4 wherein the electrode protection sleeve is composed of a pedestal and a prominence, and when the pedestal is installed into the fillister, the prominence sticks out the fillister to limit the longitudinal movement of the lamp.

9. The assembly structure of the back light module of claim 5 wherein the electrode protection sleeve is composed of a pedestal and a prominence, and when the pedestal is installed into the fillister, the prominence sticks out the fillister to limit the longitudinal movement of the lamp.

10. The assembly structure of the back light module of claim 1 wherein a cover is further equipped on the back light position of the optical plate, the cover is assembled with the two horizontal frames and the two vertical frames.

11. The assembly structure of the back light module of claim 1 wherein the optical plate is selected from a group of a light guide plate and a diffusion plate.
